(19) United States
(12) Patent Application Publication
(10) Pub. No.: US 2025/0210292 A1
(43) Pub. Date: Jun. 26, 2025

(54) ELECTRICAL CONTACTOR

(71) Applicant: Suzhou Littelfuse OVS Co., Ltd., Suzhou (CN)

(72) Inventors: Jianye Shi, Suzhou City (CN); Zhibo Liu, Suzhou (CN); Dewei Zhang, Suzhou (CN)

(73) Assignee: Suzhou Littelfuse OVS Co., Ltd., Suzhou, JS (CN)

(21) Appl. No.: 18/966,580

(22) Filed: Dec. 3, 2024

(30) Foreign Application Priority Data
Dec. 22, 2023 (CN) 2023117761920

(51) Int. Cl. H01H 50/02; H01H 50/44

(52) U.S. Cl. CPC H01H 50/02; H01H 50/44

(57) ABSTRACT

An electrical contactor including first and second stationary contacts, a movable contact disposed on a first end of a movable shaft that extends through a core and that is connected at a second end to an armature, an electromagnet coil surrounding the core, a first magnetic latching element disposed on the movable shaft, and a second magnetic latching element disposed adjacent the first and second stationary contacts, wherein, when the electromagnetic coil is energized, the core attracts the armature, thereby moving the movable shaft and bringing the movable contact into engagement with the first and second stationary contacts to allow electrical current to flow therebetween, wherein the electrical current induces a magnetic flux in the first and second magnetic latching elements, whereby the first and second magnetic latching elements are magnetized and are attracted to one another.

### CROSS-REFERENCE TO CORRESPONDING APPLICATIONS

This application claims the benefit of priority to, Chinese Patent Application No. 2023117761920, filed Dec. 22, 2023, entitled “ELECTRICAL CONTACTOR,” which application is incorporated herein by reference in its entirety.

### Field of the Disclosure

The present disclosure relates generally to the field of circuit protection devices and relates more particularly to an electrical contactor adapted to handle short circuit currents.

### Background of the Disclosure

A contactor is an electrically controlled switch used for switching power in an electrical circuit, such as in an electric vehicle. In a typical configuration, a contactor includes a fixed core and a movable armature surrounded by an electromagnet coil. The armature is attached to an electrically conductive movable contact by a shaft. When the coil is energized, it produces an electromagnetic field around the core that attracts the armature, which in turn moves the movable contact into engagement with a pair of stationary contacts. The movable contact provides an electrically conductive pathway between the stationary contacts and allows current to flow through the contactor (e.g., from an automobile battery to various electrical systems within an automobile). When the coil is deenergized, the armature is allowed to move away from the core, which moves the movable contact away from the stationary contacts to break the electrical pathway therebetween. The flow of current through the contactor is thereby arrested.

When the coil of a contactor is energized, a generally planar surface of the movable contact is moved into engagement with respective, generally planar surfaces of the stationary contacts to allow the flow of electrical current therebetween. Though the engaging surfaces of the movable contact and the stationary contacts may appear to be perfectly flat to the naked eye, they are actually uneven and irregular on a microscopic level. Thus, the movable contact and the stationary contacts may only engage each other at a number of very small points (e.g., at microscopic peaks on the surfaces of the movable contact and the stationary contacts). These small points of contact act as bottlenecks through which the current is transmitted between the surfaces, with the path of the current curving or deviating as the current is “funneled” through the bottlenecks. This deviation in the path of the current generates a magnetic flux which produces forces (commonly referred to as Lorentz forces) that act on the current and that tend to drive the movable contact and the stationary contacts away from each other.

During normal operation of an electrical contactor the Lorentz forces are very weak and are not sufficient to separate the movable contact from the stationary contacts. However, during a short circuit fault condition, an abnormally large current flows through the stationary contacts and the movable contact, generating significant Lorentz forces that can cause the movable contact to move out of engagement with the stationary contacts. Due to the large amount of electrical current flowing through the contactor during a short circuit fault condition, the separation of the movable contact from the stationary contacts can produce violent electrical arcing, which can result in catastrophic damage to the contactor and to surrounding components.

One way to address the above-described problem is to increase the electromagnetic force generated by the coil of a contactor, thereby increasing the force with which the movable contact is held in engagement with the stationary contacts. However, this approach requires a larger coil, thus increasing the size and cost of a contactor.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

An electrical contactor according to an embodiment of the present disclosure may include a first stationary contact and a second stationary contact disposed in a spaced apart arrangement, a movable contact located adjacent the first stationary contact and the second stationary contact, the movable contact disposed on a first end of a movable shaft that extends through a core and is connected at a second end to an armature, an electromagnet coil surrounding the core, a first magnetic latching element disposed on the movable shaft adjacent the movable contact, and a second magnetic latching element disposed adjacent the first stationary contact and the second stationary contact, wherein, when the electromagnetic coil is energized, the electromagnetic coil generates a magnetic field around the core to produce an electromagnetic force that attracts the armature, thereby moving the movable shaft and bringing the movable contact into engagement with the first stationary contact and the second stationary contact to establish an electrical pathway therebetween, and wherein, when electrical current flows through the movable contact between the first stationary contact and the second stationary contact, the electrical current induces a magnetic flux in the first magnetic latching element and the second magnetic latching element, whereby the first magnetic latching element and the second magnetic latching element are magnetized and are attracted to one another.

An electrical contactor according to another embodiment of the present disclosure may include an electrically insulating housing including a base and a cap removably affixed to a top of the base. The electrical contactor may further include a first stationary contact and a second stationary contact disposed in a spaced apart arrangement within the cap, a first terminal electrically connected to the first stationary contact and a second terminal electrically connected to the second stationary contact, wherein the first terminal and the second terminal extend through respective apertures in the cap, a movable contact disposed within the cap and located adjacent the first stationary contact and the second stationary contact, the movable contact disposed on a first end of a movable shaft that extends through a core and is connected at a second end to an armature, wherein the core and the armature are disposed within the base, an electromagnet coil disposed within the base and surrounding the core, a first magnetic latching element disposed on the movable shaft adjacent the movable contact, and a second magnetic latching element disposed within the cap adjacent the first stationary contact and the second stationary contact, wherein, when the electromagnetic coil is energized, the electromagnetic coil generates a magnetic field around the core to produce an electromagnetic force that attracts the armature, thereby moving the movable shaft and bringing the movable contact into engagement with the first stationary contact and the second stationary contact to establish an electrical pathway therebetween, and wherein, when electrical current flows through the movable contact between the first stationary contact and the second stationary contact, the electrical current induces a magnetic flux in the first magnetic latching element and the second magnetic latching element, whereby the first magnetic latching element and the second magnetic latching element are magnetized and are attracted to one another.

### BRIEF DESCRIPTION OF THE DRAWINGS

FIG. 1 is a cross-sectional view illustrating an electrical contactor in accordance with an exemplary embodiment of the present disclosure in a deenergized state;

FIG. 2 is a cross-sectional view illustrating the electrical contactor shown in FIG. 1 in an energized state;

FIG. 3 is a perspective view illustrating a cap of the electrical contactor shown in FIG. 1;

FIG. 4A is a detailed perspective view illustrating a movable contact and related components of the electrical contactor shown in FIG. 1;

FIG. 4B is a detailed side view illustrating the movable contact and related components shown in FIG. 4A.

### DETAILED DESCRIPTION

Embodiments of an electrical contactor in accordance with the present disclosure will now be described more fully with reference to the accompanying drawings, in which preferred embodiments of the present disclosure are presented. The electrical contactor of the present disclosure may, however, be embodied in many different forms and should not be construed as being limited to the embodiments set forth herein. Rather, these embodiments are provided so that this disclosure will be thorough and complete, and will convey certain exemplary aspects of the electrical contactor to those skilled in the art. In the drawings, like numbers refer to like elements throughout unless otherwise noted.

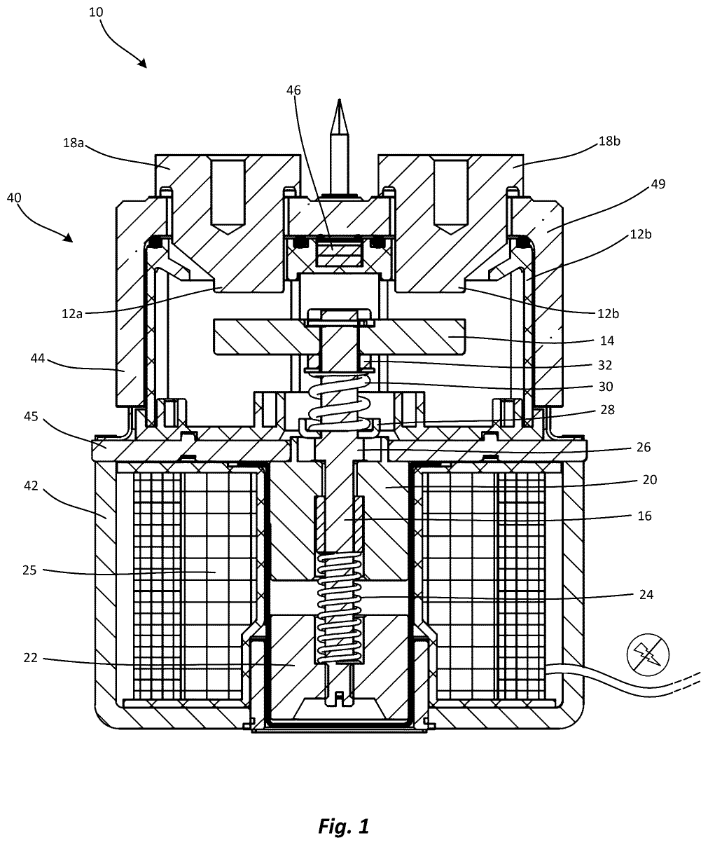

Referring to FIG. 1, a cross-sectional view illustrating an electrical contactor 10 (hereinafter “the contactor 10”) in accordance with an exemplary embodiment of the present disclosure is shown. For the sake of convenience and clarity, terms such as “top,” “bottom,” “up,” “down,” “upper,” “lower,” “vertical,” and “horizontal” may be used herein to describe the relative positions and orientations of various components of the contactor 10, all with respect to the geometry and orientation of the contactor 10 as it appears in FIG. 1. Said terminology will include the words specifically mentioned, derivatives thereof, and words of similar import.

The contactor 10 may generally include first and second stationary contacts 12a, 12b spaced apart from one another and located above a movable contact 14 disposed on a movable shaft 16. The shaft 16 may be configured to move in an axial direction to move the movable contact 14 into and out of engagement with the stationary contacts 12a, 12b as further described below. The stationary contacts 12a, 12b may be contiguous with, or electrically connected to, respective first and second terminals 18a, 18b that may be used to connect the contactor 10 within a circuit (e.g., between a source of electrical power and a load). A lower portion of the shaft 16 may extend through a cylindrical, ferromagnetic core 20, and may terminate at its lower end in a cylindrical, ferromagnetic armature 22. A restoring spring 24 may be disposed between the core 20 and armature 22 and may bias the armature 22 downwardly, away form the core 20 as further described below. The restoring spring 24 may be a coil spring that radially surrounds the shaft 16, for example. An electromagnet coil 25 may surround the core 20 and the armature 22 and may be connected to a source of electrical power (not shown).

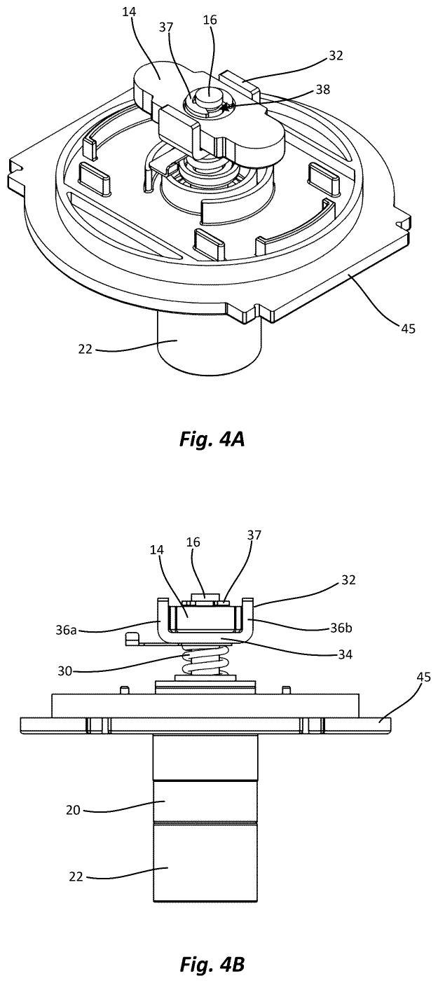

An upper portion of the shaft 16 may include an annular retaining flange 26 projecting radially therefrom. An annular spring support washer 28 may be disposed atop the retaining flange 26, and a retaining spring 30 may be disposed atop the spring support washer 28. The retaining spring 30 may be a coil spring that radially surrounds the shaft 16, for example. A first magnetic latching element 32 formed of ferromagnetic material (e.g., low carbon steel) may be disposed atop the retaining spring 30. As best shown in FIGS. 4A and 4B, the first magnetic latching element 32 may be generally U-shaped, having a floor 34 and opposing sidewalls 36a, 36b extending vertically from opposite edges of the floor 34. The shaft 16 may extend vertically through an aperture in the floor 34, and the movable contact 14 may be seated atop the floor 34 between the sidewalls 36a, 36b, with the shaft 16 extending vertically through an aperture in the movable contact 14. A C-clip 37 may be fastened to the shaft 16 (e.g., clipped into an annular groove 38 in the shaft 16) at a location above the movable contact 14 to prevent the movable contact 14 from being lifted off of the shaft 16. The present disclosure is not limited in this regard.

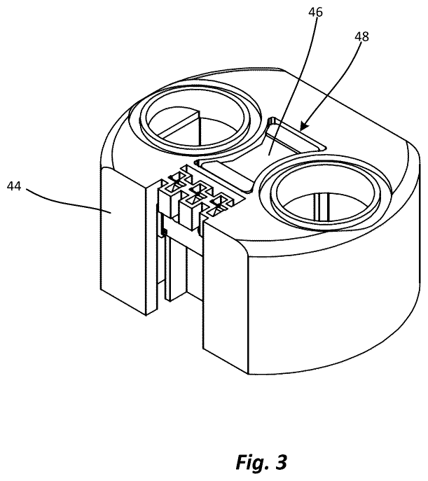

Referring to FIG. 1, the contactor 10 may further include a housing 40 formed of an electrically insulating material (e.g., plastic or composite). The housing 40 may include a base 42 that houses the core 20, the armature 22, and the coil 25. The housing 40 may further include a cap 44 (see also FIG. 3) that can be removably affixed to a top of the base 42 and that houses the first magnetic latching element 32, the movable contact 14, and the first and second stationary contacts 12a, 12b. The cap 44 may be covered by a protective casing 49. The shaft 16 may extend into both the base 42 and the cap 44 through a top 45 of the base 42. The first and second terminals 18a, 18b may extend from the first and second stationary contacts 12a, 12b through respective apertures in the cap 44 and the casing 49. As best shown in FIG. 3, a second magnetic latching element 46 may be disposed within a complementary cavity 48 formed in a top of the cap 44. The second magnetic latching element 46 may be a generally planar plate formed of ferromagnetic material (e.g., low carbon steel). The second magnetic latching element 46 may be secured within the cavity 48 using epoxy, for example. The present disclosure is not limited in this regard.

In FIG. 1 the contactor 10 is shown in a deenergized state, with the restoring spring 24 forcing the armature 22 downwardly, away from the core 20, which in-turn pulls the moveable contact 14 downwardly (via the shaft 16), away from the stationary contacts 12a, 12b. Thus, there is no electrical pathway between the stationary contacts 12a, 12b and no electrical current can flow therebetween.

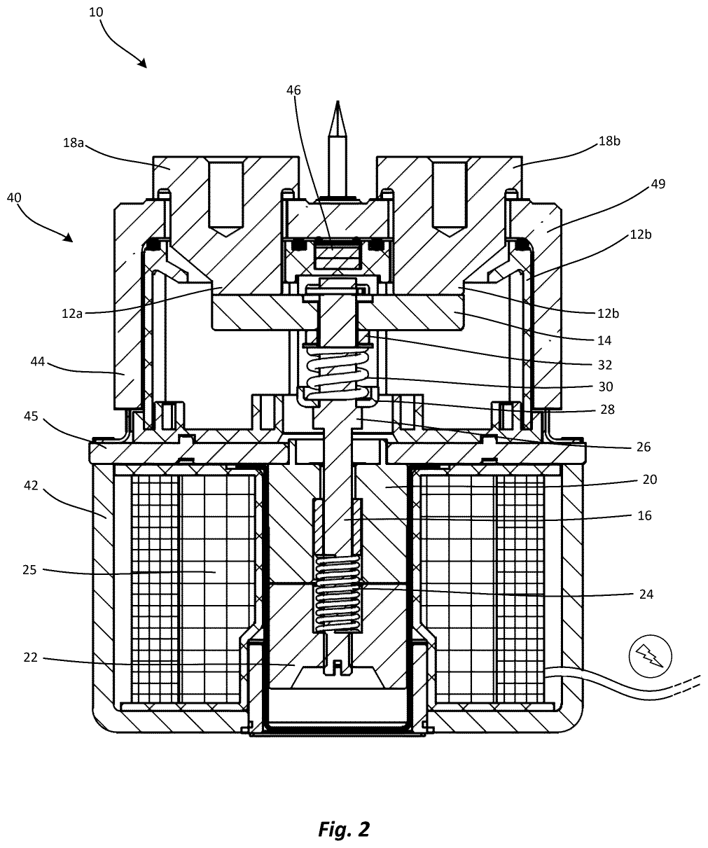

Referring to FIG. 2, the contactor 10 is shown in an energized state, wherein electrical current is supplied to the coil 25, such as by an electrical control unit (ECU) of an automobile (not shown). When the coil 25 is energized thusly, the coil 25 generates a magnetic field around the core 20, producing an electromagnetic force that attracts the armature 22. The electromagnetic force may be sufficient to pull the armature 22 upwardly, compressing the restoring spring 24, which in-turn pushes the moveable contact 14 upwardly (via the shaft 16), into engagement with the stationary contacts 12a, 12b. Additionally, the retaining spring 30 may be compressed between the spring support washer 28 and first magnetic latching elements 32, thereby exerting an upwardly directed force on the movable contact 14 to hold the movable contact 14 in firm engagement with the stationary contacts 12a, 12b. The moveable contact 14 thus provides an electrically conductive bridge between the stationary contacts 12a, 12b, allowing electrical current to flow therebetween.

Additionally, when the contactor 10 is energized as shown in FIG. 2, the current flowing through the movable contact 14 may induce a magnetic flux in the first and second magnetic latching elements 32, 46 (which have been moved into close proximity with one another), whereby the first and second magnetic latching elements 32, 46 are magnetized and are attracted to one another. The force of magnetic attraction between the first and second magnetic latching elements 32, 46 may increase as the amount of electrical current flowing through the contactor 10 increases. Thus, in the case of a short circuit fault condition, where an abnormally large current (e.g., a current in a range of 6 kiloamps to 8 kiloamps) may flow through the contactor 10, the force of magnetic attraction between the first and second magnetic latching elements 32, 46 may be very strong (e.g., in a range of 20 Newtons to 25 Newtons). Particularly, the force of magnetic attraction between the first and second magnetic latching elements 32, 46 may be stronger than Lorentz forces generated by the electrical current that would tend to drive the movable contact 14 and the stationary contacts 12a, 12b away from each other. The movable contact 14 is thereby held in firm engagement with the stationary contacts 12a, 12b, thus protecting against catastrophic electrical arcing that could otherwise occur if the movable contact 14 was driven away from the stationary contacts 12a, 12b (i.e., by Lorentz forces) during a short circuit fault condition.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. An electrical contactor comprising:
a first stationary contact and a second stationary contact disposed in a spaced apart arrangement;
a movable contact located adjacent the first stationary contact and the second stationary contact, the movable contact disposed on a first end of a movable shaft that extends through a core and is connected at a second end to an armature;
an electromagnet coil surrounding the core;
a first magnetic latching element disposed on the movable shaft adjacent the movable contact; and
a second magnetic latching element disposed adjacent the first stationary contact and the second stationary contact;
wherein, when the electromagnetic coil is energized, the electromagnetic coil generates a magnetic field around the core to produce an electromagnetic force that attracts the armature, thereby moving the movable shaft and bringing the movable contact into engagement with the first stationary contact and the second stationary contact to establish an electrical pathway therebetween; and
wherein, when electrical current flows through the movable contact between the first stationary contact and the second stationary contact, the electrical current induces a magnetic flux in the first magnetic latching element and the second magnetic latching element, whereby the first magnetic latching element and the second magnetic latching element are magnetized and are attracted to one another.

2. The electrical contactor of claim 1, wherein the first magnetic latching element is U-shaped, having a floor located below the movable contact and having first and second sidewalls extending from the floor on opposite sides of the movable contact.

3. The electrical contactor of claim 1, further comprising a housing formed of an electrically insulating material, the housing comprising:
a base that houses the core, the armature, and the electromagnet coil; and
a cap removably affixed to a top of the base, wherein the cap houses the first magnetic latching element, the movable contact, the first stationary contact, and the second stationary contact.

4. The electrical contactor of claim 3, further comprising a first terminal electrically connected to the first stationary contact and a second terminal electrically connected to the second stationary contact, wherein the first terminal and the second terminal extend through respective apertures in the cap.

5. The electrical contactor of claim 4, wherein the second magnetic latching element is disposed within a cavity in the cap.

6. The electrical contactor of claim 5, further comprising a restoring spring located between the core and the armature that biases the armature away from the core.

7. The electrical contactor of claim 6, wherein the restoring spring is a coil spring that surrounds the movable shaft.

8. The electrical contactor of claim 6, wherein, when the electromagnetic coil is deenergized, the restoring spring pushes the armature away from the core, thereby moving the movable shaft and moving the movable contact out of engagement with the first stationary contact and the second stationary contact.

9. The electrical contactor of claim 1, further comprising:
a retaining flange extending radially from the movable shaft;
a spring support washer disposed atop the retaining flange; and
a retaining spring disposed atop the spring support washer;
wherein the first magnetic latching element is disposed atop the retaining spring.

10. The electrical contactor of claim 9, wherein the retaining spring is a coil spring that surrounds the movable shaft.

11. An electrical contactor comprising:
an electrically insulating housing comprising:
a base; and
a cap removably affixed to a top of the base;
a first stationary contact and a second stationary contact disposed in a spaced apart arrangement within the cap;
a first terminal electrically connected to the first stationary contact and a second terminal electrically connected to the second stationary contact, wherein the first terminal and the second terminal extend through respective apertures in the cap;
a movable contact disposed within the cap and located adjacent the first stationary contact and the second stationary contact, the movable contact disposed on a first end of a movable shaft that extends through a core and is connected at a second end to an armature, wherein the core and the armature are disposed within the base;
an electromagnet coil disposed within the base and surrounding the core;
a first magnetic latching element disposed on the movable shaft adjacent the movable contact; and
a second magnetic latching element disposed within the cap adjacent the first stationary contact and the second stationary contact;
wherein, when the electromagnetic coil is energized, the electromagnetic coil generates a magnetic field around the core to produce an electromagnetic force that attracts the armature, thereby moving the movable shaft and bringing the movable contact into engagement with the first stationary contact and the second stationary contact to establish an electrical pathway therebetween; and
wherein, when electrical current flows through the movable contact between the first stationary contact and the second stationary contact, the electrical current induces a magnetic flux in the first magnetic latching element and the second magnetic latching element, whereby the first magnetic latching element and the second magnetic latching element are magnetized and are attracted to one another.

12. The electrical contactor of claim 11, wherein the first magnetic latching element is U-shaped, having a floor located below the movable contact and having first and second sidewalls extending from the floor on opposite sides of the movable contact.

13. The electrical contactor of claim 11, wherein the second magnetic latching element is disposed within a cavity formed in a top of the cap.

14. The electrical contactor of claim 11, further comprising a restoring spring located between the core and the armature that biases the armature away from the core.

15. The electrical contactor of claim 14, wherein the restoring spring is a coil spring that surrounds the movable shaft.

16. The electrical contactor of claim 15, wherein, when the electromagnetic coil is deenergized, the restoring spring pushes the armature away from the core, thereby moving the movable shaft and moving the movable contact out of engagement with the first stationary contact and the second stationary contact.

17. The electrical contactor of claim 11, further comprising:
a retaining flange extending radially from the movable shaft;
a spring support washer disposed atop the retaining flange; and
a retaining spring disposed atop the spring support washer;
wherein the first magnetic latching element is disposed atop the retaining spring.

18. The electrical contactor of claim 17, wherein the retaining spring is a coil spring that surrounds the movable shaft.
